(19) United States
(12) Patent Application Publication
(10) Pub. No.: US 2022/0090231 A1
(43) Pub. Date: Mar. 24, 2022

(54) Method of Mineral Recovery

(71) Applicant: St-Georges Eco-Mining Corp., Montreal (CA)

(72) Inventor: Enrico DI CESARE, Montreal (CA)

(73) Assignee: St-Georges Eco-Mining Corp., Montreal, QC (CA)

(21) Appl. No.: 17/423,676

(22) PCT Filed: Jan. 20, 2020
(86) PCT No.: PCT/CA2020/050057

§ 371 Date: Jul. 16, 2021

Related U.S. Application Data
(60) Provisional application No. 62/794,414, filed on Jan. 18, 2019.

(51) Int. Cl. C22B 26/12; C22B 3/06; C22B 3/08; C22B 7/00; H01M 10/54; H01M 10/0525; C04B 11/26

(52) U.S. Cl. CPC C22B 26/12; C22B 3/065; C22B 3/08; C04B 2111/0062; H01M 10/54; H01M 10/0525; C04B 11/266; C22B 7/007

(57) ABSTRACT

A process for the selective recovery of lithium values from feedstock is provided. The process includes concentration by one or more of air classification and flotation; selective leaching to remove Mg, Ca or Na formations; and leaching/sonication with an acid. Further, a method of beneficiating a lithium-containing ore is provided treating an aqueous pulp of the lithium-containing ore with a conditioning reagent; and floating, lithium values fraction of the lithium-containing ore from gangue slimes, wherein the treating improves the selectivity of an anionic collector to one or more of spodumene and said lithium values. Further, a process for the selective recovery of lithium from lithium ion batteries is provided.

### FIELD OF THE INVENTION

The present disclosure broadly relates to a process for selectively recovering metal values from various feedstocks such as slims, clay and hard rock. More specifically, but not exclusively, the present disclosure relates to a process for selectively recovering lithium and converting by-products to salable items such as fertilizer.

Due to salable by-products, the total operating cost for lithium production of various products such as lithium carbonate, lithium hydroxide is less than it is expected to allow producers to have lower overall costs or less of a chemical total cost. In addition, the invention allows for the production of lithium metal and lithium alloys for the growing static battery market.

### BACKGROUND

Slims and clays are difficult to concentrate comparatively to hard rock ores. In all three cases, impurities can increase the consumption of acid and neutralization chemicals. Lower grade slims and clays increase the size of the capital investment as well as energy costs. Spodumene and lepidolite require high temperature and pressure or roasting to successfully leach this crystalline form. In all cases, selective leaching allows for reduction of impurities entering the solution with simplified purification steps.

The focus of the development was to unlock resources such as clays, selective leaching to reduce the elements in solution and to maximize by products that can be consumed such as fertilizer.

The present disclosure refers to a number of documents, the contents of which are specifically incorporated herein by reference in their entirety.

### SUMMARY OF THE INVENTION

In accordance with an aspect of the present invention, there is provided a process for the selective recovery of lithium values from feedstock. The process includes concentration by one or more of air classification and flotation; selective leaching to remove Mg, Ca or Na formations; and leaching/sonication with an acid.

In accordance with an aspect of the present invention, there is provided a method of beneficiating a lithium-containing ore. The method includes: treating an aqueous pulp of the lithium-containing ore with a conditioning reagent; and floating, lithium values fraction of the lithium-containing ore from gangue slimes, wherein the treating improves the selectivity of an anionic collector to one or more of spodumene and said lithium values.

In accordance with an aspect of the present invention, there is provided a process for the selective recovery of lithium from lithium ion battery. The process includes removing the packaging from the battery; and selective leaching of lithium with an acid, leaving at least one of aluminum and iron oxide behind.

### BRIEF DESCRIPTION OF DRAWINGS

In the figures, which illustrate by way of example only, embodiments of the present invention,

FIG. 1 is a simplified schematic diagram of a process, exemplary of an embodiment of the present invention, illustrating fertilizer production routes; and

FIG. 2 is simplified schematic diagram of a process for electrowinning in one embodiment of the present invention; and

FIG. 3 is simplified schematic diagram of a process for electrowinning in another embodiment of the present invention.

### DETAILED DESCRIPTION

### Glossary

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this disclosure pertains.

Unless otherwise indicated, the definitions and embodiments described in this and other sections are intended to be applicable to all embodiments and aspects of the application herein described for which they are suitable as would be understood by a person skilled in the art.

The word “a” or “an” when used in conjunction with the term “comprising” in the claims and/or the disclosure may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used in this disclosure and claim(s), the word “consisting” and its derivatives, are intended to be close ended terms that specify the presence of stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The terms “about”, “substantially” and “approximately” as used herein mean a reasonable amount of deviation of the modified term such that the end result is not significantly changed. These terms of degree should be construed as including a deviation of at least ±1% of the modified term if this deviation would not negate the meaning of the word it modifies.

As used herein, the term “lithium feedstocks” refers to a range of materials containing lithium in solid forms such as slims, clay and hard rocks ranging in different crystalline forms such as lithium oxides and spodumenes. These materials may contain potassium crystalline forms such as potassium oxides/chlorides among other forms. In addition MgO is commonly found in these feedstocks as well as Calcium.

Digestion is used broadly and refers to an acid digesting a solid with Nitric Acid in the range of 10 to 90%. Depending on the feed most spodumene or lepidolite require 60 to 90% concentrations of HNO₃.

The term “substantially” as used herein with reference to the process steps disclosed herein means that the process steps proceed to an extent that conversion or recovery of the material is maximized. For example, with reference to recovery of a given metallic value (e.g. lithium, MgO, potassium), recovery means that at least 50% of the value is recovered.

The term “purification” is used in reference to liquid separation of the lithium with a resin or solvent extraction

The term “calcination” as used herein refers to conversion of LiOH to LiO, MgOH to MgO, altering the microstructure of spodumene and lepidolite and or adding oxygen to facilitate the leach ability of these forms of lithium.

### EMBODIMENTS

Embodiments of the present invention utilize leaching which avoids the use of high temperature and high-pressure vessels. Depending on the raw material recovery of magnesium, potassium, magnesium nitrate, calcium nitrate, and sodium nitrates are possible by using embodiments of the present invention.

Lithium concentrates are achievable with froth flotation by changing the density of the solution by saturating it with salts and column flotation to improve the selectivity of the flotation. This is applicable to super fines like clays that can easily carry over untargeted crystals just by the flow of air particles due to the size and weight of the particles. The density change of the solution helps concentrate the particles.

Depending on the feed raw material air classification may be successfully applied by only drying if required, de-agglomeration of the material followed by creating a slurry with the saturated salt solution. MgCl₂, silica salt were both used successfully.

Even with improved flotation, concentrates similar to spodumene concentrates of 4 to 6% lithium are not achievable. Concentrates of 1% to 3% lithium require selective leaching to reduce the elements that can hamper the purification steps. Nitric acid as a passivating acid was shown to leach mainly salt metals such as calcium, magnesium, sodium and lithium as well as carbonates.

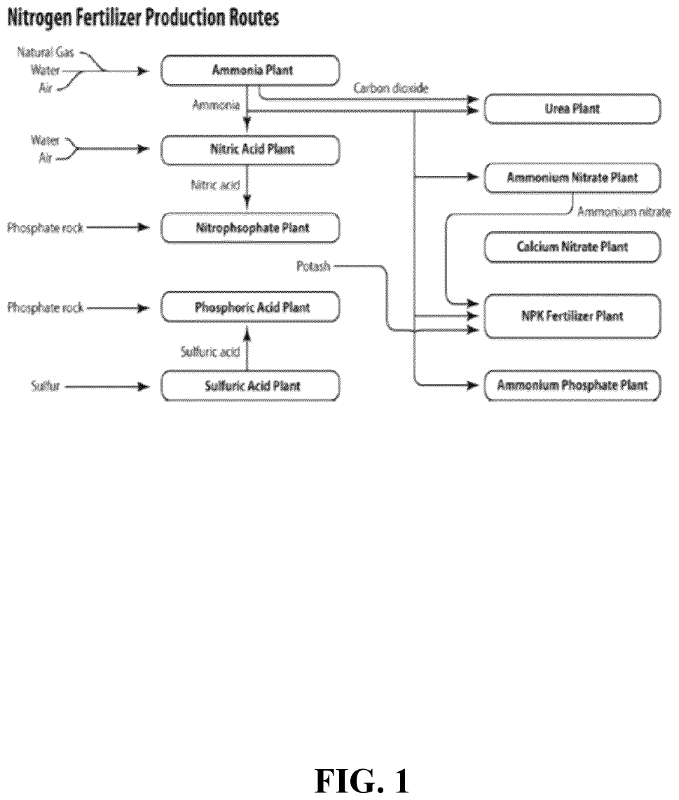

These elements are complementary to fertilizers for nitrate additions. In addition, excess nitric acid and nitrates can be combined with phosphate feeds to make nitro-phosphate fertilizers as shown in FIG. 1.

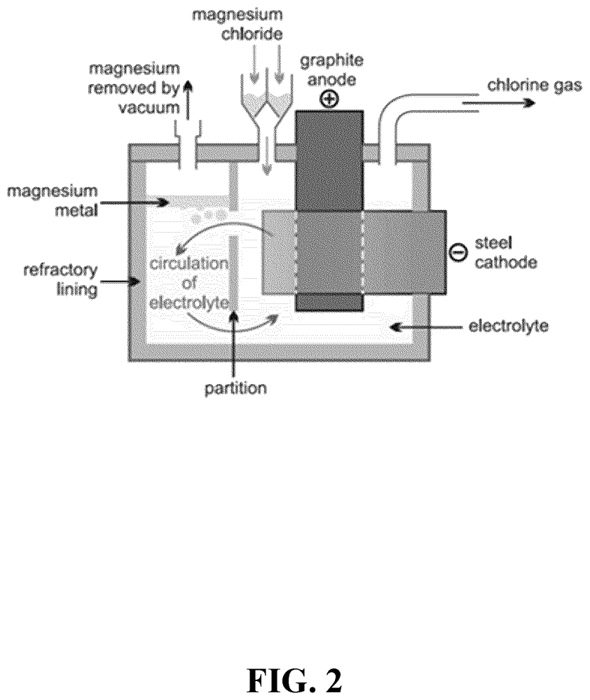

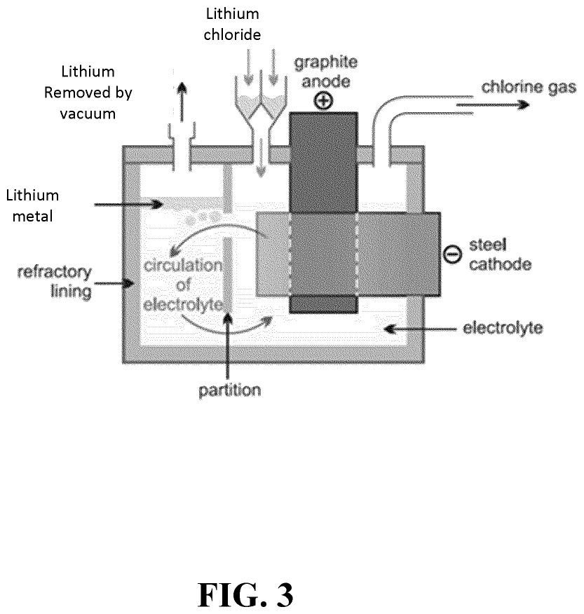

Lithium hydroxide produced through electrowinning has never been produced with a nitric acid base. In addition when calcined can be converted to a LiO of high purity and this is ideal to make lithium metal or an alloy of lithium and Mg. This feed blended with stoichiometric requirements of carbon with pet coke, coke ties up the oxygen as CO and CO₂ and the liquid lithium is sent to the electro-winning process to make the lithium metal. Chlorine gas recovered is sent back to the lithium chloride reactor as shown in FIG. 2 and FIG. 3.

For fines: according to an embodiment of the present invention, the lithium values fraction of lithium-containing ores is floated from gangue slimes, clay materials such as those found at Bonnie Claire, depending on size distribution can be concentrated with a saturated salt solution or upgraded by half like for Bonnie Claire with air classification.

By a froth flotation process wherein an aqueous pulp of the ore is treated with a conditioning reagent, which improves the selectivity of anionic collectors to spodumene and other lithium values. More specifically, the conditioning reagent is formed by incorporating a water-soluble polyvalent metal salt into an aqueous solution of a water-soluble alkali metal silicate. The conditioning reagent is added to and thoroughly mixed with the ore pulp before the pulp is subjected to conventional froth flotation in the presence of an anionic collector as the flotation agent.

In addition to this improvement to reduce the processing plant size by also selectively concentrating elements that are worth recovering such as potassium. Once in a slurry potassium concentrates can be achieved with the same method as lithium due to the density of the solution having changed.

With super fines column flotation achieves the best results. For partial improvement air classification improved the total concentration of lithium by approximately double and 55% of the total weight was reduced.

The other item in the discovery that by concomitant leaching and sonication a pregnant solution can ultimately be obtained while avoiding high temperature, pressure leaching and the need to roast materials like spodumene materials rich in lithium. The lithium enriched solution is then fed to purification plant to make products of lithium carbonate and or lithium hydroxide and or lithium metal.

Materials high in MgO or CaO can have substantial requirements for purification after leaching with chemicals to remove such elements and or the use of membranes. The invention allows for the selective leaching and removal of MgO and CaO with leaching the targeted lithium allowing for simpler process plant steps. In addition, the MgO can be recovered as a salable high purity product with fewer chemicals and less effort.

This improvement allows many resources overlooked with high MgO as a possible lithium resource that is now economically recoverable. Mg acts as a stabilizer for Li in metal form and can be used in static batteries as an alloy.

In an aspect, the present disclosure relates to a process for the selective recovery of MgO, potassium and other elements as well as lithium with byproducts of fertilizer for the nitrate portion and the potential to use spent nitric acid with accumulated impurities to produce value added nitro-phosphates using apatite concentrates or other concentrates of P₂O₅. Gypsum byproducts can be sold for drywall. Mg as an example is required as an addition where fertilizers such as potassium sulfate are used as those crops such as almonds and pomegranates deplete the earth of Mg.

Nitric acid in the range of 10% to 90% has successfully been used to leach spodumene other hard rock resources covering slims, clay and hard rock. This does not require pressure, sonification, or high temperatures. Nitric acid passivates many metals and helps to reduce the amount of elements that enter solution such as potassium, iron, nickel to name a few. Lithium leaches easily and can be recovered with resins and solvent extraction to make high purity lithium products. Due to the selective nature of the leach mainly salt metals are leached and principally Mg which allows for the production of lithium magnesium alloys without additional purification.

By adding the right amount of sulfuric acid stoichiometrically, Ca can be removed to have a high purity Gypsum produced that can be used for dry wall for example. This eliminates one residue. Afterwards, principally Mg and Li remain in the solution. In brines Mg, Na, Ca have larger ions than Li and can be separated with a membrane. The same may be used to get Mg and Li products as well as Mg Nitrates.

Purification of the lithium is performed by using a resin to selectively collect the lithium. Depending on the feed with high levels of Mg and Ca a separation step with a membrane can be used to separate Mg and Ca from the solution containing the lithium. The ion size of Mg and Ca is larger than Li allowing for this separation. This is not necessary in all cases and may only have to be applied to ratios of Mg to Li ratios of above 6 to 1 in solution. Lithium was selectively collected with organics as well. Resins utilized citric acid to help with pH adjustment.

In the case for lithium manganese alloys only the calcium is removed by addition of H₂SO₄ stoichiometrically. Depending on the metal alloy of Mg and Li the ratios may be adjusted before electrolysis, calcining and electro winning of the metal. LiOH is produced by electrolysis. This helps to recover chemicals and reduces chemicals to achieve the process. This is the final product for many clients or is fed to the metal production facility.

LiOH is calcined when lithium metal is planned for production. The present disclosure does not cover all aspects the preparation of the lithium such as rolling into foil for static batteries as proposed by Hydro Quebec. The calcined lithium hydroxide is converted to lithium oxide (LiO) for pelletizing or briquetting to be fed to a fluidized bed for the reactions. Chlorine gas flows through the bed of the lithium pellets or briquettes reacting with the lithium oxide. Coke is added stoichiometric ally to bond with the oxygen for the following reactions:

2LiO+2C+Cl₂=2LiCl+2CO

Lithium chloride is liquid at 700C and the fluidized bed will be operated above this temperature to encourage the liquid lithium chloride to drain to the electrowinning cell.

2LiCl+electrical energy=2Li+Cl₂

The chlorine is collected and returned to be reused at the fluidized bed as a closed loop with minor additions.

In an embodiment of the present disclosure, the selective leaching to remove MgO, CaO and Na (all forms) Li (in forms of LiO, spodumene and lepidolite). Selective leaching represents the digestion of salt family metals preferentially over other elements.

Electrolysis of lithium refers to producing LiOH from LiNO₃. The reactions are as follows:

2LiNO₃+2H₂O±2e⁻→H₂+NO₃+2LiOH.

NO₃ gases are recovered to regenerate HNO₃.

Lithium metal production refers to the calcination of the LiOH by calcining to remove excess H₂O and convert the product to LiO. Inert gas such as nitrogen or argon are necessary to control the lithium and maintain its form of LiO. This is fed to a chlorinator to produce LiCl₂ liquid with CO and CO₂ byproduct from the coke additions stoichiometric ally. The liquid LiCl₂ is fed to an electrowinning circuit to produce Li metal and captures the Cl₂ which is returned to the beginning of the reactor to react with new LiO fed to the reactor.

In an embodiment of the present disclosure, the ultrasound-assisted extraction process comprises the concentration by air classification and or flotation and leaching/sonication of lithium and other valuables from a feedstock.

In an embodiment of the present disclosure, the leaching is performed using nitric acid over a period ranging 5 minutes to 120 minutes depending on the surface area of the feed.

Clay feeds that are ultrafine are closer to the 5-minute time requirement.

In the further embodiment, the purification is performed with a resin controlling the pH as required with citric acid.

Other Sources

It is contemplated that Lithium Ion Batteries may be recycled using alternate embodiments of the present invention. As may be appreciated by persons of skill in the art, lithium can be recovered from old lithium ion batteries. In one embodiment, recycling Lithium Ion Batteries may involve the following steps:

Initially the packaging is removed. The aluminum foil coated with the FeLiPO₄ is shredded then and can be blended with any of the hard rock type lithium products such as clays, spodumene or lepidolite or treated separately. By calcining, the phosphate is gasified and recovered in the bag house as it cools. The remaining mixture of Fe, Aluminum oxides is fed to the same leach reactor as described above. The calcining step is not necessary as phosphate and nitrates can be used as fertilizer but high purity phosphate can also be recovered for new battery production this way. The nitric acid preferentially leaches the lithium leaving aluminum and iron oxide behind. Undigested aluminum and iron, for example, is filtered out and may be used in a further recycling process for aluminum recovery by reusing the steps enumerated above. The recovered phosphate can be used for new batteries or fertilizer.

The ability to recover lithium units from old batteries is very useful and potentially addresses new and future markets for static batteries.

It is contemplated that any part of any aspect or embodiment discussed in this specification may be implemented or combined with any part of any other aspect or embodiment discussed in this specification. While particular embodiments have been described in the foregoing, it is to be understood that other embodiments are possible and are intended to be included herein. It will be clear to any person skilled in the art that modification of and adjustment to the foregoing embodiments, not shown, is possible.

The scope of the claims should not be limited by the example embodiments set forth herein, but should be given the broadest interpretation consistent with the description as a whole.

What is claimed is:

1. A process for the selective recovery of lithium values from feedstock, the process comprising:
(a) concentration by one or more of air classification and flotation;
(b) selective leaching to remove one or more of Mg, Ca and Na formations; and
(c) leaching/sonication with an acid.

2. The process of claim 1, wherein said Mg and Ca formations are MgO and CaO respectively.

3. The process of claim 1, further comprising providing an added substance to enhance leaching.

4. The process of claim 3, wherein the substance comprises H₂SO₄.

5. The process of claim 1, wherein said selective leaching comprises using Nitric acid.

6. The process of claim 5, wherein the nitric acid is used in concentrations from 10% to 90%.

7. The process of claim 1, wherein the acid is sulfuric acid.

8. The process of claim 7, wherein the acid is said nitric acid and the leaching/sonication is performed over a period ranging from about 5 minutes up to about 120 minutes.

9. The process of claim 8, wherein the feedstock is ultra fine clay and said period is closer to said 5 minutes.

10. The process of claim 1, wherein said step of concentration by air classification approximately doubles the concentration of said lithium values.

11. The process of claim 1, wherein said step of concentration by air classification comprises drying.

12. The process of claim 1, wherein said step of selective leaching to remove Ca formations further comprises addition of H₂SO₄ stoichiometrically.

13. The process of claim 12, wherein the process results in high purity Gypsum.

14. The process of claim 13, wherein the Gypsum is suitable for use in drywall.

15. A method of beneficiating a lithium-containing ore, the method comprising:
(a) treating an aqueous pulp of the lithium-containing ore with a conditioning reagent; and
(b) floating, lithium values fraction of the lithium-containing ore from gangue slimes, wherein said treating improves the selectivity of an anionic collector to one or more of spodumene and said lithium values.

16. The method of claim 11, wherein said floating utilizes a froth flotation process.

17. The method of claim 11, wherein the conditioning reagent is formed by incorporating a water-soluble polyvalent metal salt into an aqueous solution of a water-soluble alkali metal silicate.

18. The method of claim 12, wherein the conditioning reagent is added to and thoroughly mixed with the pulp before the pulp is subjected to conventional froth flotation in the presence of an anionic collector as the flotation agent.

19. A process for the selective recovery of lithium from lithium ion battery, the process comprising:
(a) removing a packaging from the battery; and
(b) selective leaching of lithium with an acid, leaving at least one of aluminum and iron oxide behind.

20. The process of claim 19, wherein the acid is nitric acid.

21. The process of claim 19, further comprising filtering out undigested aluminum and iron and for reuse in a subsequent recycling process for aluminum recovery.

22. The process of claim 19, further comprising calcining to gasify phosphate present in the battery.

23. The process of claim 19, wherein said packaging comprises aluminum foil coated with the FeLiPO₄, the process further comprising shredding said foil.
